(19) United States
(12) Patent Application Publication
(10) Pub. No.: US 2015/0125298 A1
(43) Pub. Date: May 7, 2015

(54) FLUID TURBINE FOR POWER GENERATION

(71) Applicants: Robert Clifton Vance, Arlington, TX (US); Jason Daniel Cormey, Dallas, TX (US); Bruce Eugene Swanson, Orchard Park, NY (US); Brandon D Brantley, Grand Prairie, TX (US); Francis Dudley, Arlington, TX (US); Peter Chris Skarzenski, Dallas, TX (US)

(72) Inventors: Robert Clifton Vance, Arlington, TX (US); Jason Daniel Cormey, Dallas, TX (US); Bruce Eugene Swanson, Orchard Park, NY (US); Brandon D Brantley, Grand Prairie, TX (US); Francis Dudley, Arlington, TX (US); Peter Chris Skarzenski, Dallas, TX (US)

(21) Appl. No.: 14/070,474

(22) Filed: Nov. 1, 2013

(51) Int. Cl. F03D 3/06; F03D 7/06; F03D 3/00

(52) U.S. Cl. CPC F03D 3/068; F03D 3/005; F03D 7/06
USPC 416/116; 416/112

(57) ABSTRACT

A fluid turbine comprising a rotor, having an axis of rotation, comprising at least two rotor blades disposed at a radius from the axis of rotation, each rotor blade having a pitch axis and a variable pitch angle. The fluid turbine comprises a mechanism operable to control the pitch angle of at least one rotor blade about its pitch axis and to vary the pitch angle of the rotor blade between various pitch angles as the blade moves radially about the axis of rotation of the rotor.

### CROSS REFERENCE TO RELATED APPLICATIONS

This application is a continuation-in-part application of co-pending U.S. patent application Ser. Nos. 12/954,886, 12/954,889, 12/954,893 and 12/954,895 filed Nov. 28, 2010.

### SUMMARY OF THE INVENTION

According to a first embodiment, the present disclosure relates to a fluid turbine comprising a rotor, having an axis of rotation, comprising at least two rotor blades disposed at a radius from the axis of rotation, moving along a circumferential tangent path line (TPL), each rotor blade having a pitch axis and a variable pitch angle. The fluid turbine further comprises a mechanism operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a second embodiment, the present disclosure relates to a fluid turbine comprising a rotor, having an axis of rotation, comprising at least two rotor blades disposed at a radius from the axis of rotation, moving along a circumferential tangent path line (TPL), each rotor blade having a pitch axis and a variable pitch angle. The fluid turbine further comprises a mechanism operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation to a third pitch angle at a third circumferential location about the axis of rotation.

According to a third embodiment, the present disclosure relates to a fluid turbine comprising a rotor, having an axis of rotation, comprising at least two rotor blades disposed at a radius from the axis of rotation, moving along a circumferential tangent path line (TPL), each rotor blade having a pitch axis and a variable pitch angle. The fluid turbine further comprises a mechanism operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation to a third pitch angle at a third circumferential location about the axis of rotation to a fourth pitch angle at a fourth circumferential location about the axis of rotation.

According to a fourth embodiment, the present disclosure relates to a fluid turbine comprising a rotor, having an axis of rotation, comprising at least two rotor blades disposed at a radius from the axis of rotation, each rotor blade having a pitch axis and a variable pitch angle. A blade pitch control mechanism comprises a cam and at least one rocker assembly, each rocker assembly comprising a rocker arm operable to pivot about an axis of rotation, the blade pitch control mechanism being operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a fifth embodiment, the present disclosure relates to a fluid turbine comprising a rotor, having an axis of rotation, comprising at least two rotor blades disposed at a radius from the axis of rotation, each rotor blade having a pitch axis and a variable pitch angle. A blade pitch control mechanism comprising a cam and at least one rocker assembly, each rocker assembly comprising a rocker arm operable to pivot about an axis of rotation and a cam follower bearing, secured to the distal end thereof, operable to ride on a surface of the cam, the blade pitch control mechanism being operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a sixth embodiment, the present disclosure relates to a fluid turbine comprising a frame, a rotor, comprising a hub secured to the frame in such manner as to rotate about an axis of rotation with respect thereto and at least two rotor blades disposed at a radius from the axis of rotation, each rotor blade having a pitch axis and a variable pitch angle. A blade pitch control mechanism comprises a mostly stationary cam secured to the frame and having a surface defining a rotor blade pitch profile and at least one rocker assembly, each rocker assembly comprising a rocker arm secured to the hub in such manner as to pivot about an axis of rotation with respect thereto and a cam follower bearing, secured to the distal end thereof, operable to ride on a surface of the cam, the blade pitch control mechanism being operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a seventh aspect, the present disclosure relates to a fluid turbine comprising a rotor and a phase-adjustable mechanism. The rotor has an axis of rotation, and comprises at least two rotor blades disposed at a radius from the axis of rotation, each rotor blade having a pitch axis and a variable pitch angle. The phase-adjustable mechanism is operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to an eighth aspect, the present disclosure relates to a fluid turbine comprising a rotor and a pitch angle control mechanism. The rotor has an axis of rotation, and comprises at least two rotor blades disposed at a radius from the axis of rotation, each rotor blade having a first end, a second end, a first mounting point, a second mounting point, a pitch axis and a variable pitch angle, each of the first and second mounting points being disposed inboard of the first and second ends. The pitch angle control mechanism is operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a ninth aspect, the present disclosure relates to a fluid turbine comprising a rotor and a pitch angle control mechanism. The rotor has an axis of rotation and comprises a first hub, a second hub, an array of at least two struts, having strut covers disposed thereabout, extending from each of the first and second hubs, and at least two rotor blades, each secured to the distal end of a strut and having a pitch axis and a variable pitch angle. The mechanism is operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a tenth aspect, the present disclosure relates to a fluid turbine comprising a rotor having an array of rotor blades disposed circumferentially thereabout. The rotor has an axis of rotation, and comprises at least two rotor blades disposed at a radius from the axis of rotation, each rotor blade having a pitch axis and a variable pitch angle. A pitch control mechanism is operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation. The pitch of each rotor blade is controlled via an actuating rod running from the blade to the rotor hub.

According to an eleventh aspect, the present disclosure relates to a fluid turbine comprising a rotor and a pitch angle control mechanism. The rotor has an axis of rotation, and comprises at least two rotor blades disposed at a radius from the axis of rotation, each rotor blade having a first end, a second end, a first mounting point, a second mounting point, a pitch axis and a variable pitch angle, each of the first and second mounting points being disposed inboard of the first and second ends. The pitch angle control mechanism is operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

According to a twelfth aspect, the present disclosure relates to a fluid turbine comprising a rotor and a pitch angle control mechanism. The rotor has an axis of rotation and comprises a first hub, a second hub, an array of at least two struts, having strut covers disposed thereabout, extending from each of the first and second hubs, and at least two rotor blades, each secured to the distal end of a strut and having a pitch axis and a variable pitch angle. The mechanism is operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

### BRIEF DESCRIPTION OF THE DRAWINGS

FIG. 1 is an isometric view of a fluid turbine according to certain embodiments of the present disclosure;

FIG. 2 is an end view of a fluid turbine according to certain embodiments of the present disclosure;

FIG. 3 is a graph of five profiles of rotor blade pitch (Θ) vs. rotor blade position (Ψ) about the central axis of rotation of the turbine;

FIG. 4 is a table showing, for each of the five profiles in FIG. 3, the rotor blade pitch (Θ) at ten distinct blade positions about the central axis of rotation of the turbine;

FIG. 5 is an isometric view of a rotor hub according to one embodiment of the present invention;

FIG. 6 is a top view of a rocker assembly according to certain embodiments of the present invention;

FIG. 7 is a front view of a rocker assembly according to certain embodiments of the present invention;

FIG. 8 is an end view of a rotor hub assembly according to certain embodiments of the present invention;

FIG. 9 is a three-dimensional view of a rocker arm assembly according to certain embodiments of the present invention;

FIG. 10 is a section view of the rocker arm assembly of FIG. 7;

FIG. 11 is a three-dimensional view of a rocker arm according to certain embodiments of the present invention;

FIG. 12 is a three-dimensional view of a yoke according to certain embodiments of the present invention;

FIG. 13 is a three-dimensional view of a blade pitch control link according to certain embodiments of the present invention;

FIG. 14 is an end view of one embodiment of a cam clocking mechanism disposed in the hub at the first end of the fluid turbine;

FIG. 15 is an isometric view of a second embodiment of a cam clocking mechanism;

FIG. 16 is a front view of the cam clocking mechanism of FIG. 15;

FIG. 17 is a section view of the cam clocking mechanism of FIGS. 15 and 16;

FIG. 18 is a back view of the cam clocking mechanism of FIGS. 15-17;

FIG. 19 is a side view of the cam clocking mechanism of FIGS. 15-18;

FIG. 20 is an exploded view of the cam clocking mechanism of FIGS. 15-19;

FIG. 21 is a view of the underside of a rotor blade according to certain embodiments of the present invention;

FIG. 22 is a cutaway view of the rotor blade of FIG. 21 showing the blade attachment mechanism and pitch control linkage;

FIG. 23 is a section view of a second embodiment of a rotor blade having a different attachment mechanism from the rotor blade of FIGS. 21 and 22;

FIG. 24 is a section view of a third embodiment of a rotor blade having a different attachment mechanism from the rotor blades of FIGS. 21-23;

FIG. 25 is an isometric view of the pivot assembly shown in FIG. 23;

FIG. 26 is an isometric view of the pivot assembly shown in FIG. 24;

FIG. 27 is a section view of the pivot assembly shown in FIGS. 24 and 26;

FIG. 28 is a front section view of a rotor blade showing the receiving pocket for a pivot assembly of the type shown above;

FIGS. 29 and 30 are views of a first embodiment of a turbine blade strut cover; and

FIGS. 31 and 32 are views of a second embodiment of a turbine blade strut cover.

### DETAILED DESCRIPTION OF THE DRAWINGS

A system and method of the present patent application will now be described with reference to various examples of how the embodiments can best be made and used. Like reference numerals are used throughout the description and several views of the drawings to indicate like or corresponding parts, wherein the various elements are not necessarily drawn to scale.

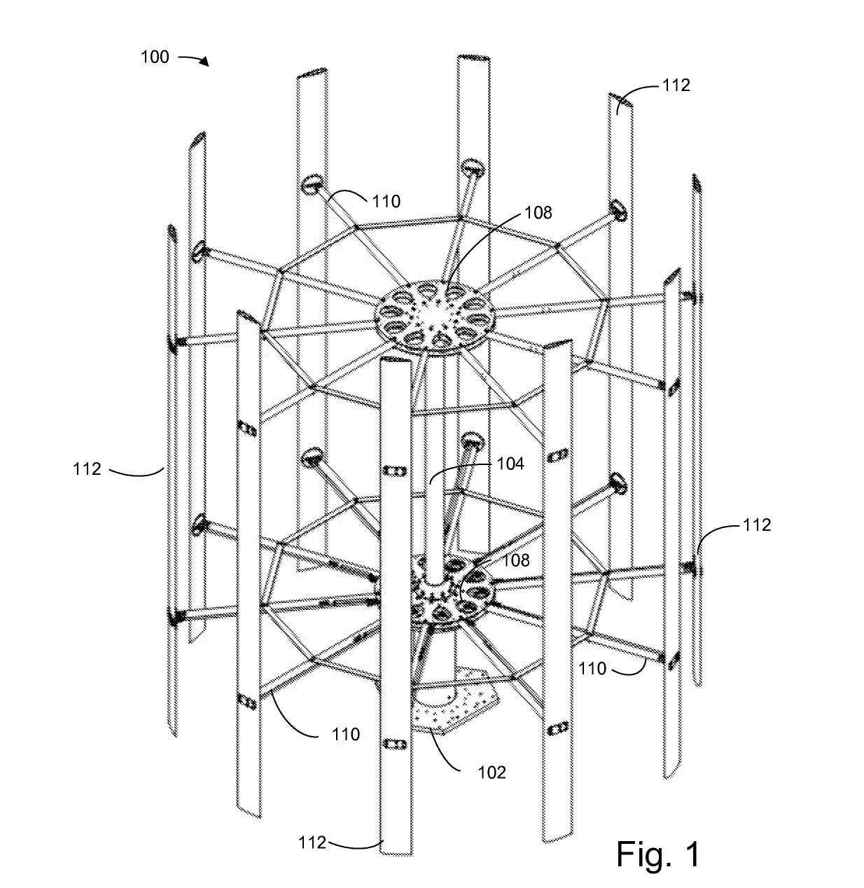

FIG. 1 is an isometric view of a fluid turbine 100 according to certain embodiments of the present disclosure. Structurally, turbine 100 consists of a rotor assembly comprising a torque tube 104 riding on bearings 106 mounted on a frame 102. Torque tube 104 is designed to prevent each rotor hub 108 from rotating independently of the other rotor hubs 108. Torque tube 104 is oriented along a central axis which is intended to be disposed generally perpendicular to the direction of fluid flow. The turbine 100 comprises arrays of radially-disposed struts 110 mounted to rotor hubs 108 at their proximal ends and to a set of rotor blades 112 at their distal ends. The rotor blades 112 shown in FIG. 1 are high aspect ratio airfoils/hydrofoils having a clearly defined leading and trailing edge. Turbine 100 shown in FIG. 1 comprises 10 blades, but alternate embodiments may have more or fewer blades, depending on the application. The rotor blades 112 are attached to the struts 110 in such a manner as to allow the rotor blades 112 to be individually pivoted with respect to the circumferential tangent path line of turbine 100, thus altering the pitch angle of each rotor blade 112 as turbine 100 rotates. The angle of the rotor blades may be controlled via mechanical linkages, hydraulics, pneumatics, linear or rotary electromechanical actuators, or any combination thereof. In certain embodiments, the rotor pitch angle profile may be controlled by a cam-and-follower mechanism operating in concert with one or more of the above systems of actuation. According to one such mechanism, a set of cam followers ride along a surface of a centrally-located cam. The profile of at least one surface of the cam defines the pitch profile or pitch schedule for the rotor blades.

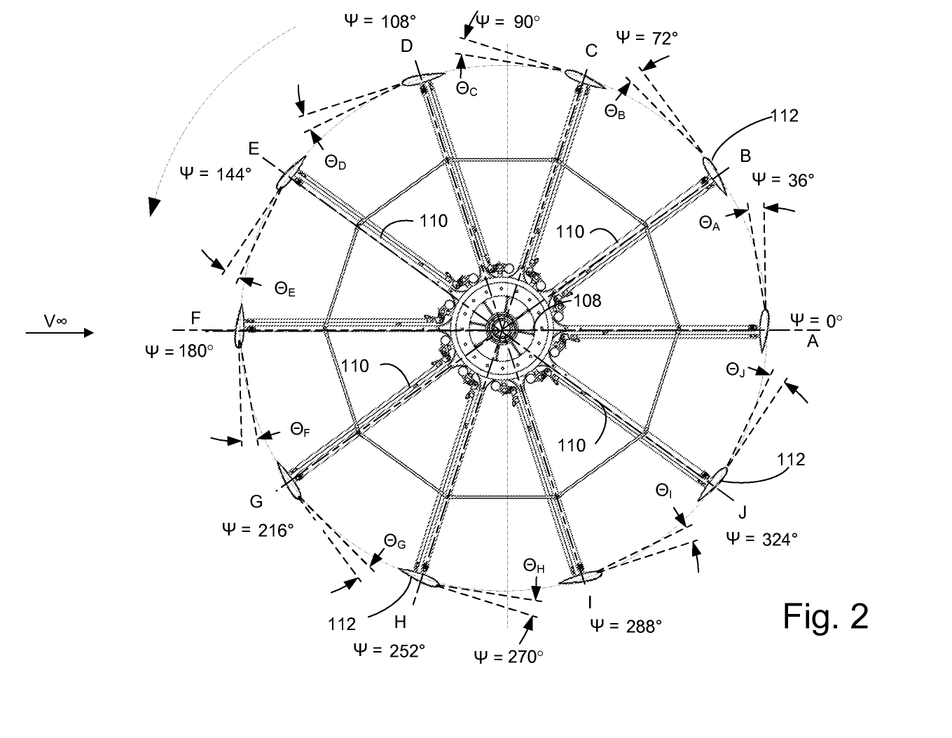

FIG. 2 is an end view of a fluid turbine 100 according to certain embodiments of the present disclosure. The fluid turbine 100 shown in FIG. 2 incorporates ten rotor blades 112. The pitch angle of the ten rotor blades 112 are designated angles A-J with the blade pitch angle of the rotor blade at angular position 0 being designated angle “A”. The blade pitch angles of the other rotor blades 112 are designated angles “B” through “J”, at multiples of 36 degrees from angle “A”, counter-clockwise. Thus, angle “B” is the pitch angle of a rotor blade 112 disposed at an angular position 36 degrees counter-clockwise from 0, angle “C” is the pitch angle of a rotor blade 112 disposed at an angular position 72 degrees from 0, and so forth.

Because of the fact that the angle between a rotor blade 112 and the fluid flow will vary as the rotor blade 112 moves around the axis of rotation of the turbine 100, the optimal pitch angle for torque generation will vary accordingly as that rotor blade 112 moves around the axis of rotation. In order to optimize the angle between the blade pitch and the fluid flow, turbine 100 disclosed herein incorporates at least one mechanism to vary the blade pitch according to angular position as a rotor blade 112 moves around the rotational axis of the turbine 100. The pattern or profile of blade pitch vs. angular position may vary depending on a number of factors, including but not limited to rotor velocity and free stream fluid velocity. Thus, it may be desirable to modify the blade pitch profile as conditions change.

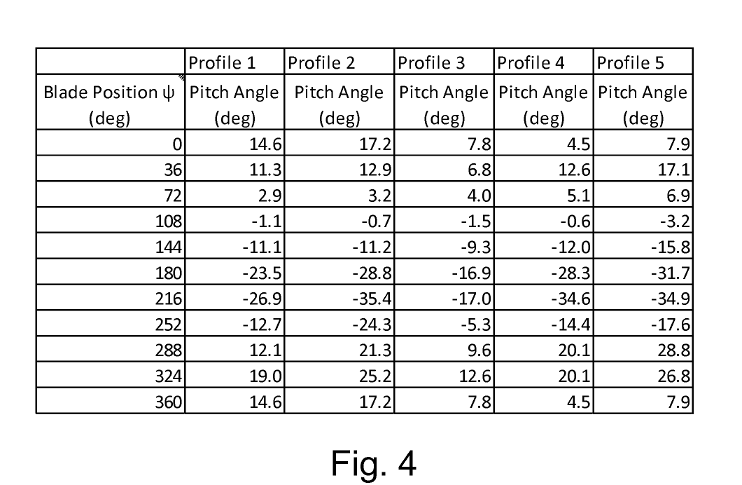

As described above, those of skill in the art will recognize that a blade pitch value of zero in FIG. 4 represents the condition wherein chord line is aligned with the circumferential tangent path line of the blade, while a positive value represents the condition wherein the nose of the blade is disposed in toward the axis of rotation of the turbine and a negative value represents the condition wherein the nose of the blade is disposed out away from the axis of rotation of the turbine.

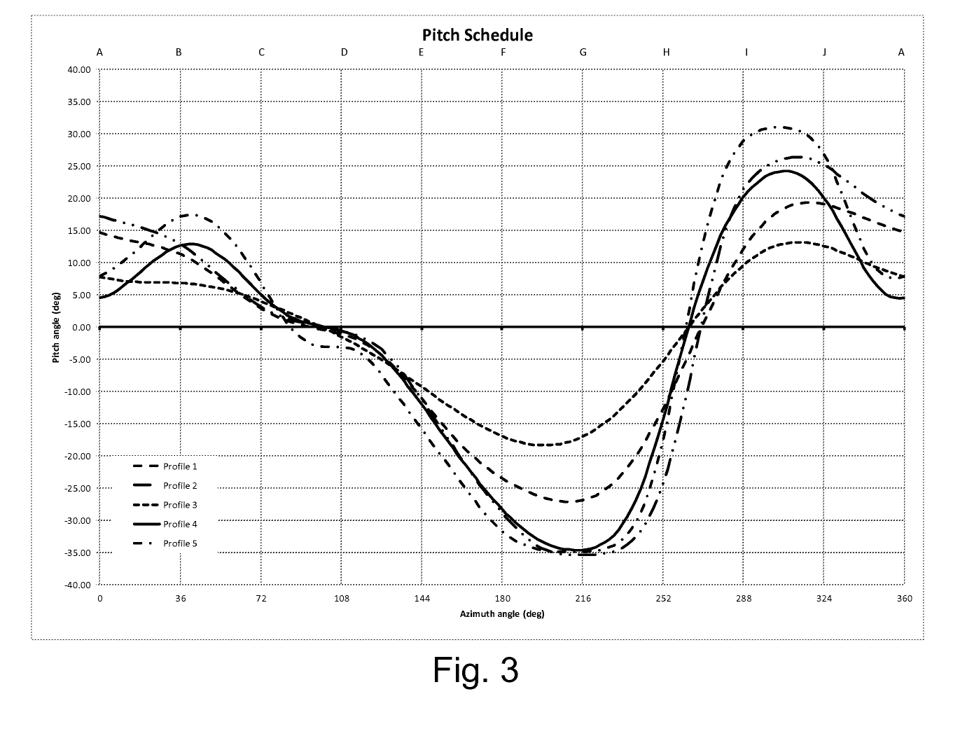

FIG. 3 is a graph of five profiles of rotor blade pitch (theta) vs. rotor blade position (psi) about the central axis of rotation of the rotor. The profiles are designated “Profile 1,” “Profile 2,” “Profile 3,” “Profile 4” and “Profile 5.” Profiles 1 through 5 are non-sinusoidal profiles, although each incorporates certain sinusoidal attributes. Angular positions A-J about the axis of rotation of the rotor are designated by the appropriate letters and correspond to the positions shown in FIG. 2. Those of skill in the art will recognize that a blade pitch value of zero represents the condition wherein the blade chord is aligned tangent to the circumferential path line along which the blade moves. This alignment may also be described as one lying normal to a vector from the axis of rotation of the rotor to the pitch axis of the rotor blade. As above, a positive value represents the condition wherein the nose of the blade is disposed in toward the axis of rotation of the turbine, while a negative value represents the condition wherein the nose of the blade is disposed out away from the axis of rotation of the turbine.

FIG. 4 is a table showing, for each of the five profiles shown in FIG. 3, the rotor blade pitch (theta) at the ten distinct blade positions A-J about the central axis of rotation of the turbine. Angular positions A-J set forth in FIG. 4 correspond to the angular positions shown in FIG. 2 about the axis of rotation of the rotor. Those of skill in the art will appreciate that the angles depicted in FIG. 4 are certain specific angles which have been shown to be useful within the context of the present disclosure. Those of skill in the art will also appreciate that similar profiles to those shown and described will be useful within the context of the present disclosure.

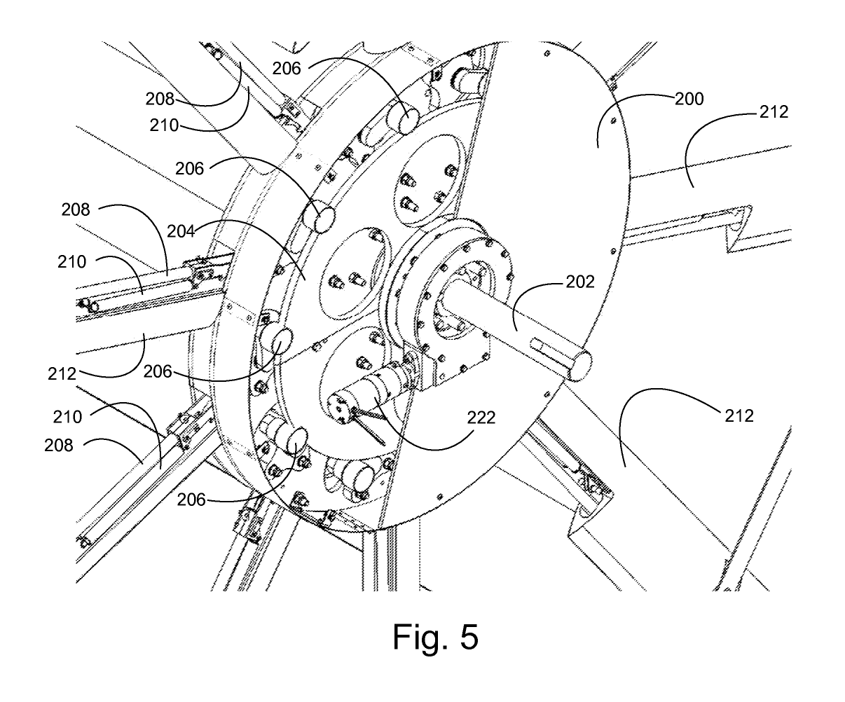

FIG. 5 is an isometric view of a rotor hub according to one embodiment of the present invention. Hub 200 revolves about a cam 204 as the rotor revolves about its axis of rotation. Cam 204 remains stationary inside hub 200 as the rotor revolves. A set of rocker assemblies 206, secured to hub 200, ride on a surface of cam 204 as the hub 200 revolves. Each rocker assembly 206 is connected to an actuation rod 208 and at least one spring 210 secured to a strut at one end and the actuation rod 208 at the other. The springs 210 hold the cam followers securely against a surface of the cam 204.

Each actuation rod 208 is secured to a rocker assembly 206 at its proximal end and to a rotor blade at its distal end. Each actuation rod 208 controls the pitch of a particular rotor blade according to the position of a particular rocker assembly 206, which is, in turn, controlled by the profile of a surface of the cam 204 at the point of contact between the cam 204 and the cam follower of the rocker assembly 206. Thus, a rotor blade at a given radial location will be articulated to a given pitch. As a rotor blade moves about the axis of rotation of the rotor, it will be articulated according to the pattern of the cam, which may be one of the patterns set forth heretofore, or may be a different pattern.

A clocking motor 222 actuates a clocking mechanism 220 secured to the cam 204. The clocking mechanism is operable to vary the phase relationship between the cam 204 and the rotor blades 106 by advancing or retarding the angular position of the cam 204 with respect to the angular position of the rotor blades 106. The structure of the clocking mechanism is set forth in further detail below.

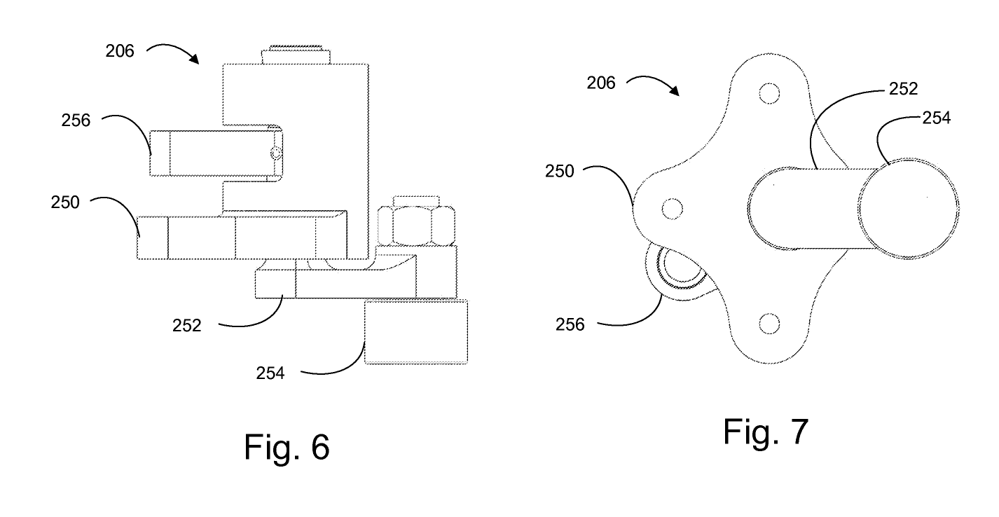

FIG. 6 is a top view of a rocker assembly according to certain embodiments of the present invention. FIG. 5 is a front view of a rocker assembly 206 according to certain embodiments of the present invention. Rocker assembly 206 comprises a rocker cartridge 250 which acts as a frame for rocker assembly 206. Rocker cartridge 250 has a cylindrical body protruding from the back of a front flange, and a generally-cylindrical aperture passing from front to back. A rocker arm 252 is mounted to a shaft passing through the cylindrical aperture in the body of the rocker cartridge 250, and mounted in such a manner as to pivot about an axis of rotation passing through the aperture. In general, rocker arm 252 will pivot on bearings of some type, which may be sleeve bearings, ball bearings or needle bearings, as examples.

A cam follower bearing 254 is secured to the distal end of the rocker arm 252 and oriented in such manner as to freely rotate about an axis of rotation generally parallel to, but offset from, the axis of rotation of the rocker arm 252. Cam follower bearing 254 is designed to ride on the outer surface of cam 204 as hub 200 revolves around stub axle 202. Cam follower bearing 254 may be selected from any one of a number of bearing types, including sleeve bearings, ball bearings or needle bearings, as examples.

As cam follower bearing 254 rides along a surface of cam 204, rocker arm 252 will pivot to follow the profile of a surface of the cam 204, thereby rotating the shaft portion passing through the aperture in the body of the rocker cartridge 250. A lever arm 256 is secured to the shaft portion in such a manner as to pivot with the rocker arm 252. The lever arm 256 is also secured to an actuation rod 208 in such a manner as to move the actuation rod 208 as the rocker arm 252 rotates. With this arrangement, the actuation rod 208 moves according to the profile of the surface of cam 204 as the rocker assembly 206 moves about the cam 206.

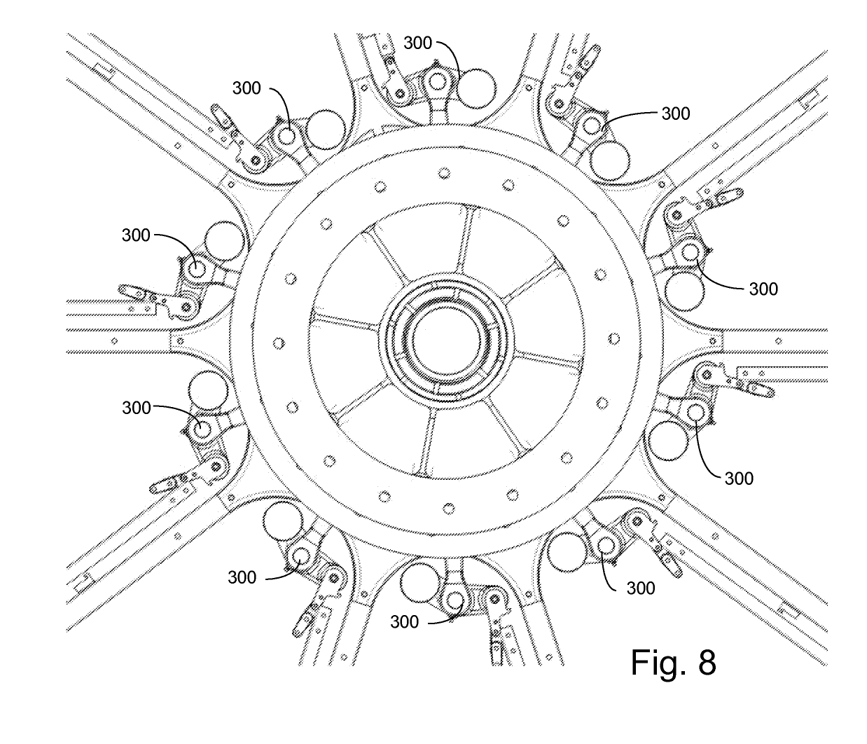

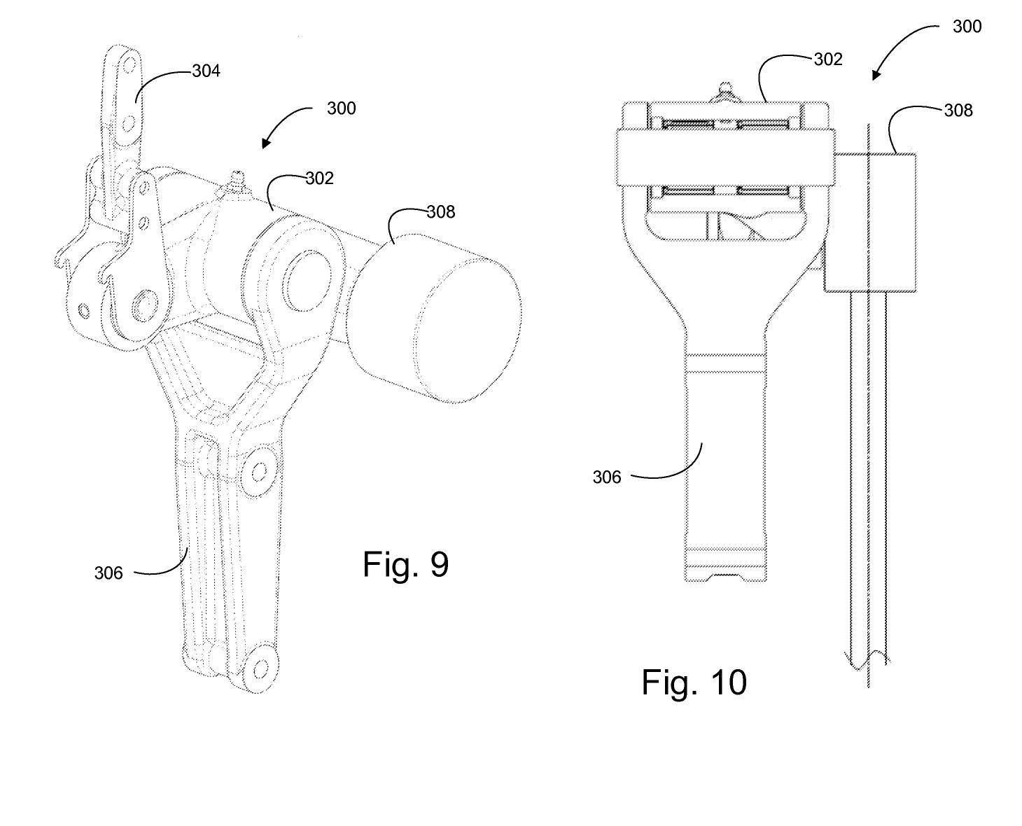

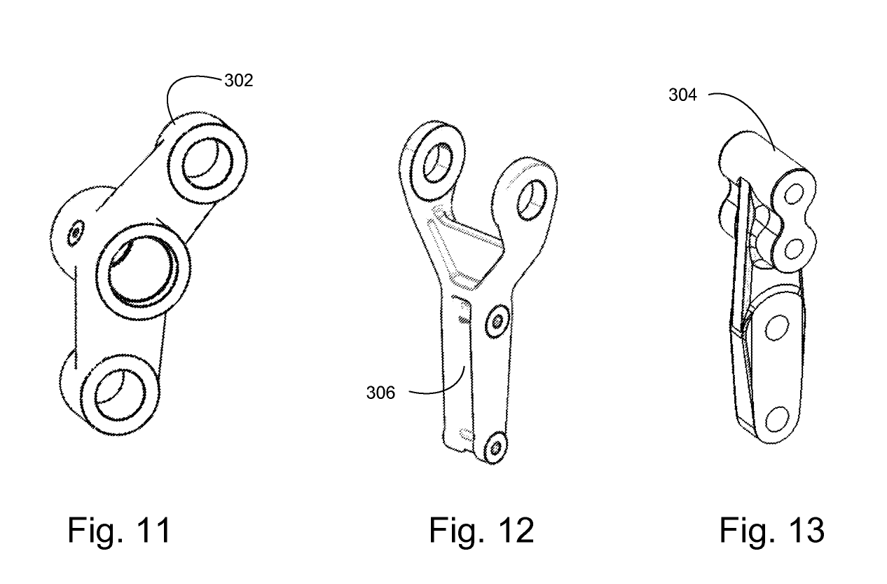

FIGS. 7-13 depict a second embodiment of a cam-and-follower mechanism according to certain embodiments of the present invention. FIG. 8 depicts an end view of a rotor hub having an array of ten rocker assemblies 300 disposed circumferentially therein. As seen in FIGS. 9 and 10, each rocker assembly 300 comprises a rocker arm 302 rotatably secured at a center pivot to a yoke 306. The rocker arm 302 has a blade pitch control link 304 secured to a first end thereof and a roller 308 secured to a second end opposite the pivot from the first end. In operation, roller 308 rides on a surface of a blade pitch control cam. The blade pitch control link 304 moves along with, but opposite to, the motion of roller 308 as it moves along the surface of the blade pitch control cam. FIGS. 9-13 depict detailed three-dimensional views of rocker arm 302, yoke 306 and blade pitch control link 304 in isolation.

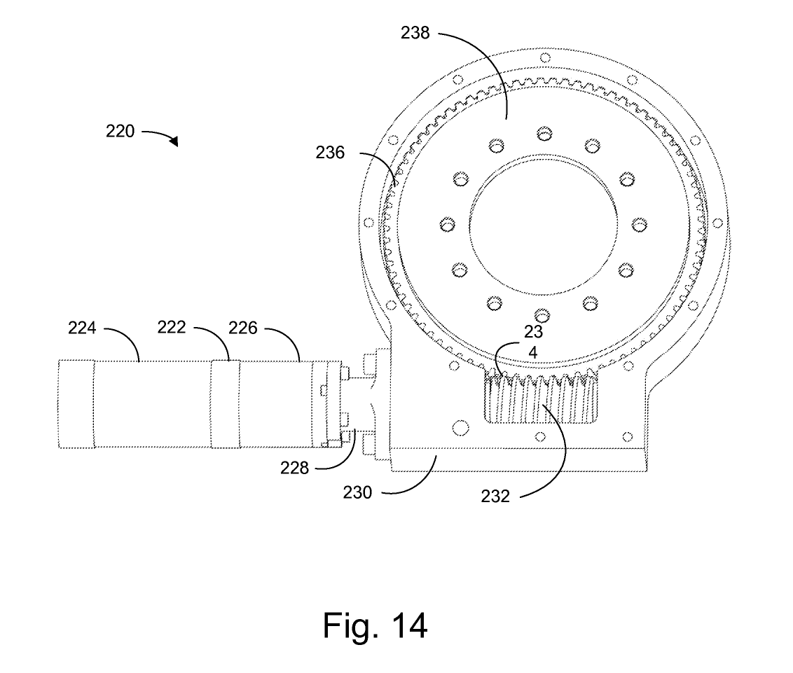

FIG. 14 is an end detail view of clocking mechanism 220. As seen above, clocking mechanism 220 comprises a clocking motor 222 secured to a worm gear mechanism 230. Clocking motor 222 comprises a rotor-stator assembly 224 and a gearhead 226, though in different embodiments, the gearhead 226 may or may not be included. Clocking motor 222 is secured to worm gear assembly 230 by motor mount 228.

Within worm gear assembly 230, the helical worm teeth 234 of worm gear 232 mesh with the helical gear teeth 236 of gear 238. As the worm gear 232 rotates, the helical worm teeth 234 exert pressure on the helical gear teeth 236, thus imparting a torque on gear 238, which is secured to cam 204. Through the use of clocking mechanism 220, the clocking motor 222 is able to vary the angle of cam 204, and thereby vary the phase of the cam profile with respect to the rotor blades in order to optimize the blade pitch profile to match the prevailing conditions, which may include fluid velocity, fluid flow direction, fluid turbulence and fluid density, as examples.

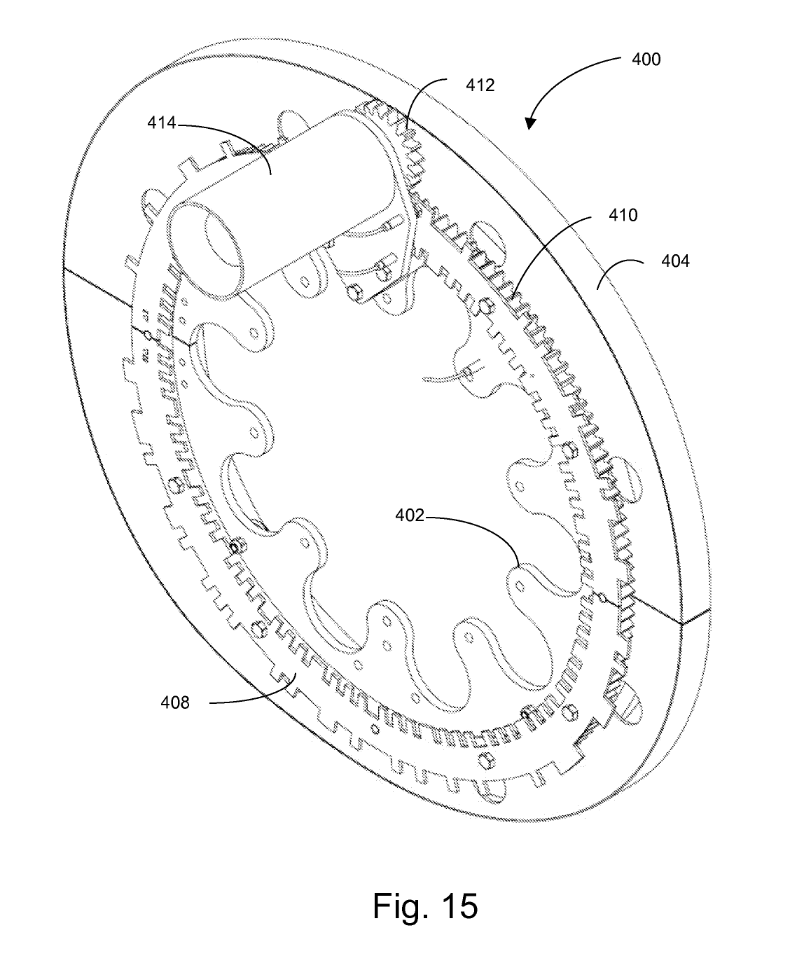

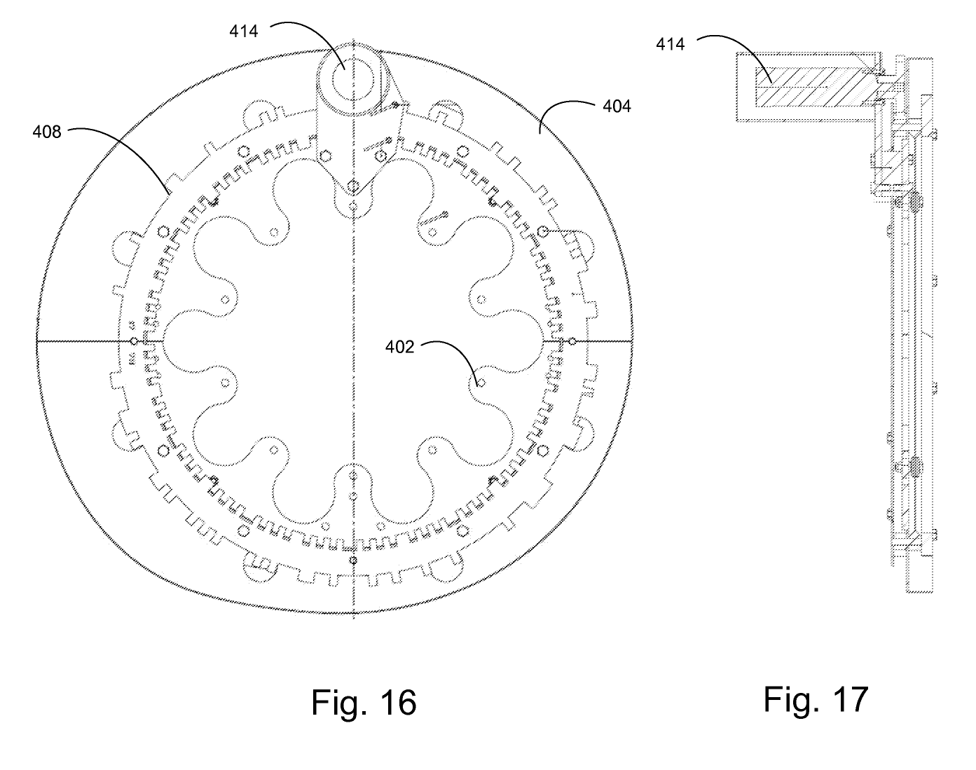

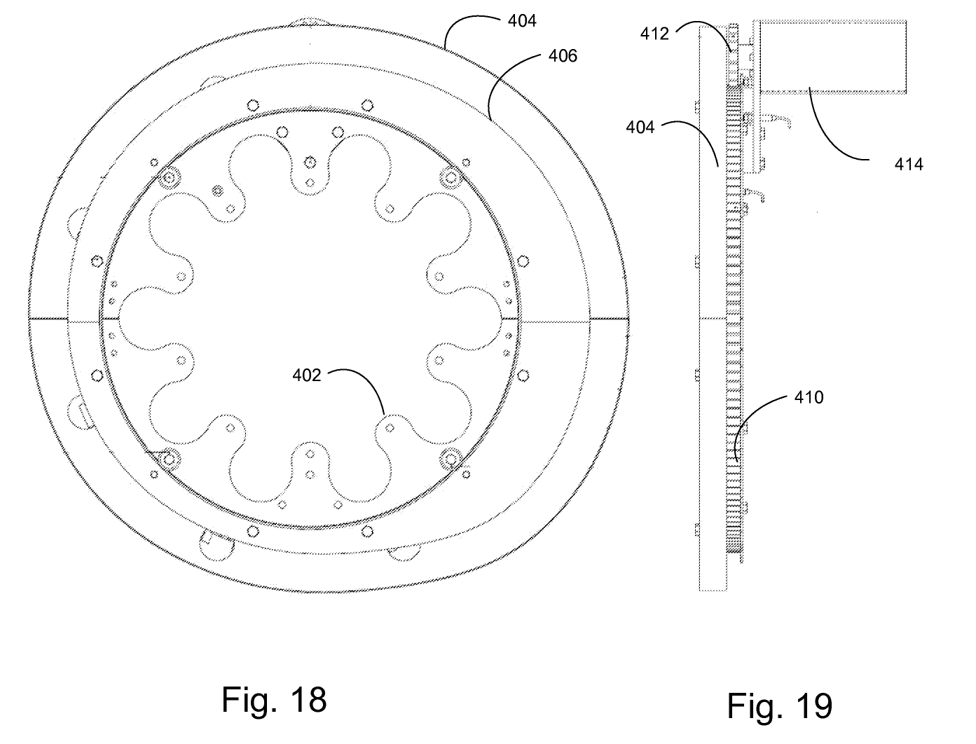

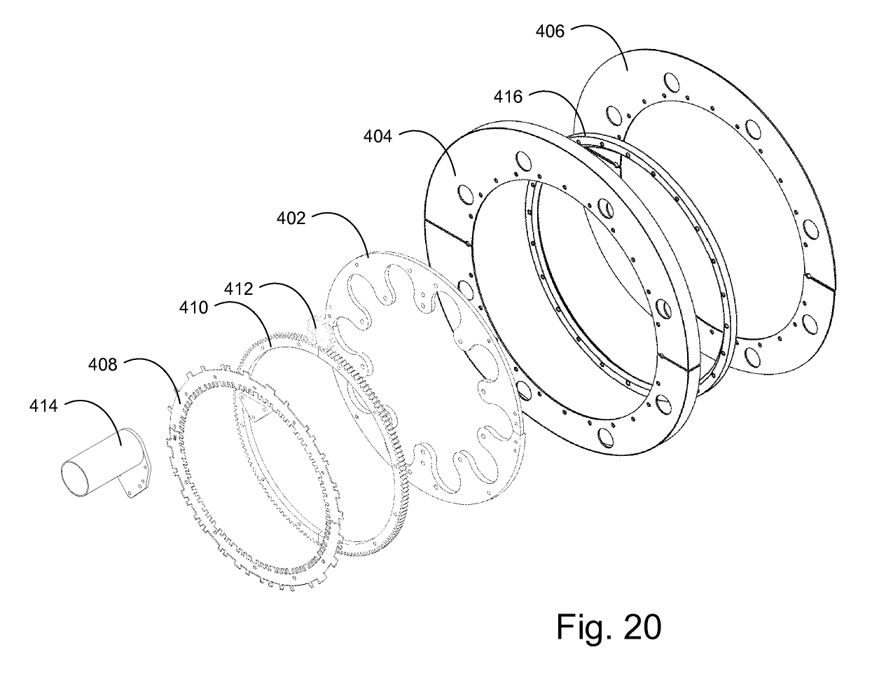

FIGS. 15-20 depict various aspects of a second embodiment of a cam clocking mechanism, designated 400. FIG. 15 is an isometric view of mechanism 400. FIG. 16 is a front view of cam clocking mechanism 400 of FIG. 15. FIG. 17 is a section view of cam clocking mechanism 400 of FIGS. 15 and 16. FIG. 18 is a back view of cam clocking mechanism 400 of FIGS. 15-17. FIG. 19 is a side view of cam clocking mechanism 300 of FIGS. 15-18. FIG. 20 is an exploded view of cam clocking mechanism 400 of FIGS. 15-19.

As seen in FIGS. 15-20, cam clocking mechanism 400 comprises a cam mounting plate 402 to which is secured a cam 406, a cam bumper plate 404, an encoder wheel 408, a driven gear 410 and a mounting ring 416. A driving gear 412, secured to a cam clocking motor 414, is meshed to the driven gear 410. The orientation and speed of the cam clocking mechanism can be controlled using the cam clocking motor 414, in a manner well known to those of skill in the art. According to certain embodiments of the present invention, cam clocking motor 414 may be selectively engageable and disengageable from driven gear 410. This may be effectuated by a mechanism operable to engage and disengage driving gear 412 to driven gear 410. Alternately, this may be effectuated by a mechanism operable to engage and disengage cam clocking motor 414 to driving gear 412.

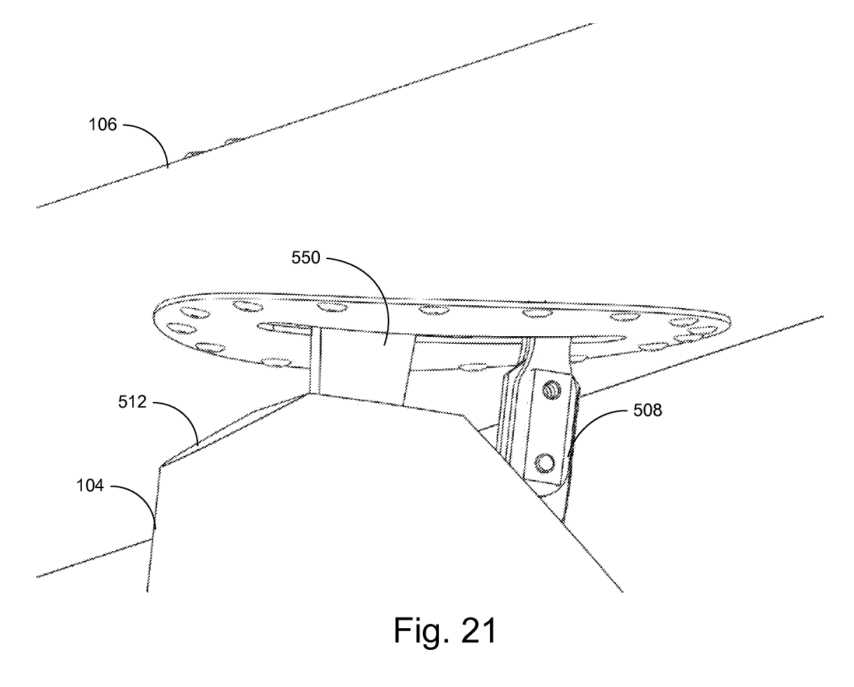

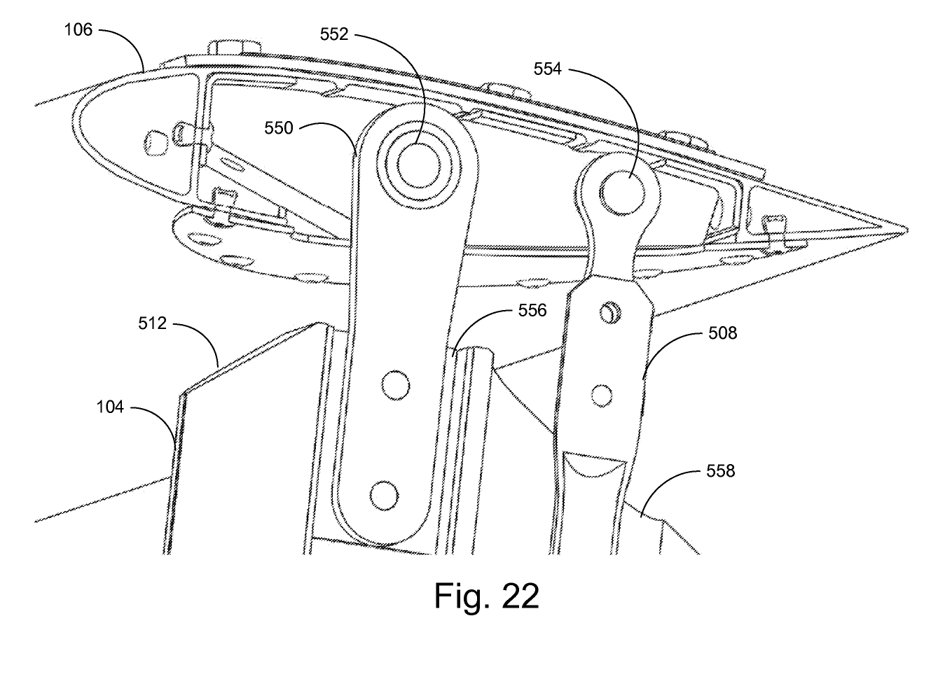

FIG. 21 is an oblique detail view of the underside of a rotor blade. FIG. 22 is an oblique cutaway view of the rotor blade showing the blade attachment mechanism and pitch control linkage. As seen in FIGS. 21 and 22, each rotor blade 106 is secured to a strut 104 by means of a pivot joint 552 allowing the rotor blade 106 freedom of movement to be moved to different pitch angles. As described above, the pitch angle of each rotor blade is controlled by an actuation rod 208 secured to the rotor blade at rod end 554. The actuation rod 208 is connected at its other end to a pitch control mechanism, such as a cam-and-follower mechanism, disposed in the rotor hub 108. Using the actuation rod 208, the pitch control mechanism is able to vary the pitch of the blade 106 as it moves through the fluid stream.

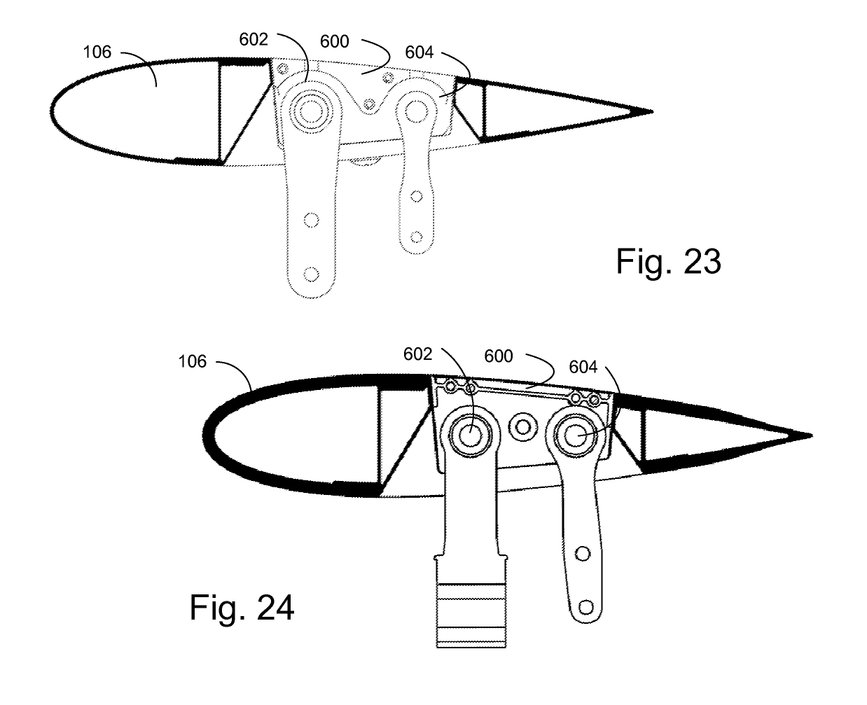

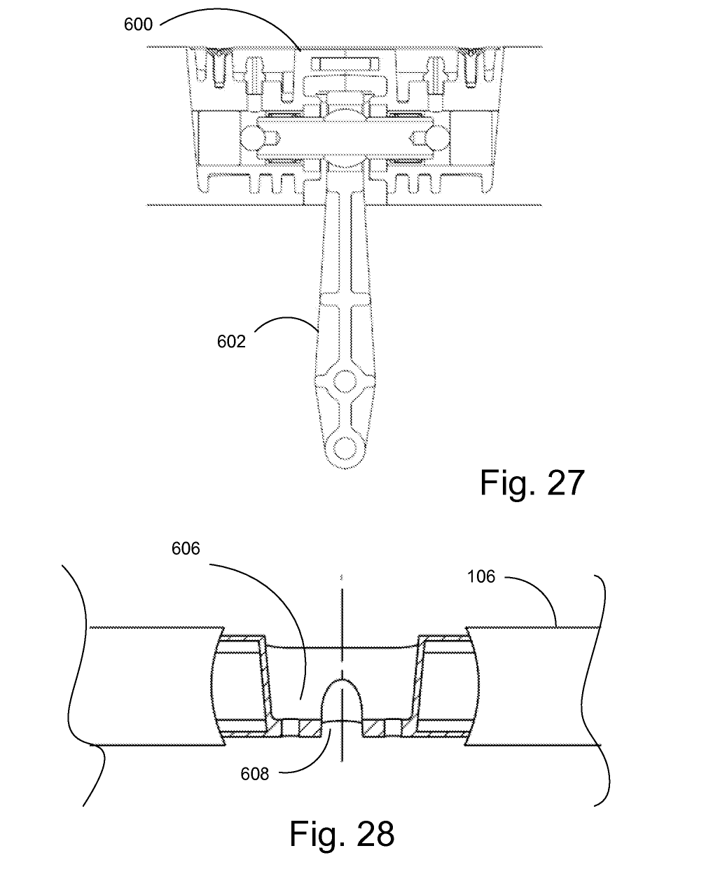

FIG. 23 is a section view of a second embodiment of a rotor blade 106 having a different attachment mechanism from the rotor blade 106 of FIGS. 21 and 22. FIG. 24 is a section view of a third embodiment of a rotor blade 106. Figure is an isometric view of a first embodiment of a pivot assembly 600 shown in FIG. 23. FIG. 26 is an isometric view of a second embodiment of a pivot assembly 600 shown in FIG. 24. FIG. 27 is a section view of the pivot assembly 600 shown in FIGS. 24 and 26. FIG. 28 is a front section view of the rotor blade 106 of FIGS. 23 and 24 showing the receiving pocket for the pivot assembly 600 of FIG. 27.

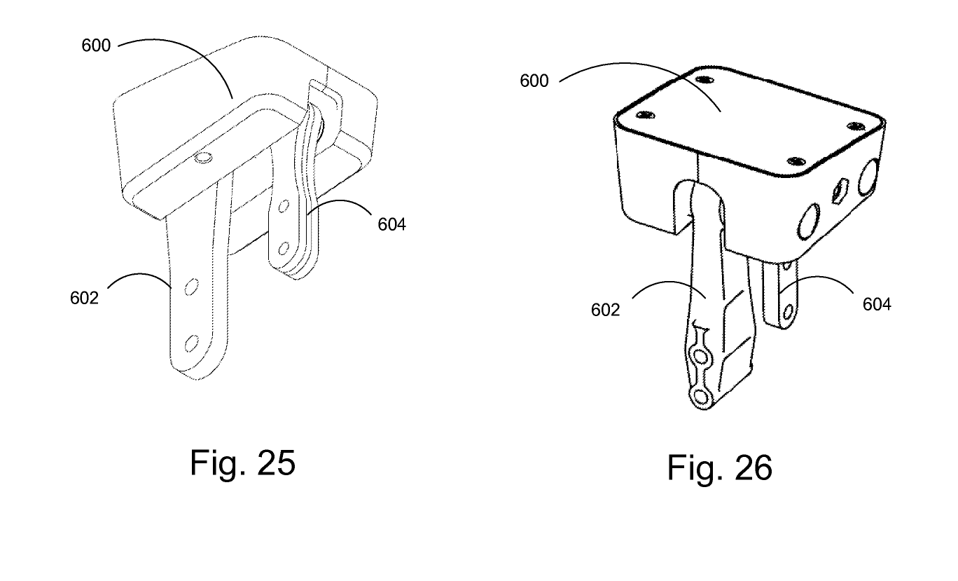

As seen in FIGS. 23-28, rotor blade 106 has a pivot assembly 600 disposed in a receiving pocket 606 in the center thereof. The pivot assembly 600 is pivotably secured to a strut rod end 602 and an actuation rod end 604, which pass through a slot 608 on the underside of rotor blade 106. In a similar manner to that described above, strut rod end 602 functions to maintain the position of rotor blade 106, while actuation rod end 604 functions to control the pitch of rotor blade 106 as it moves radially about the rotor.

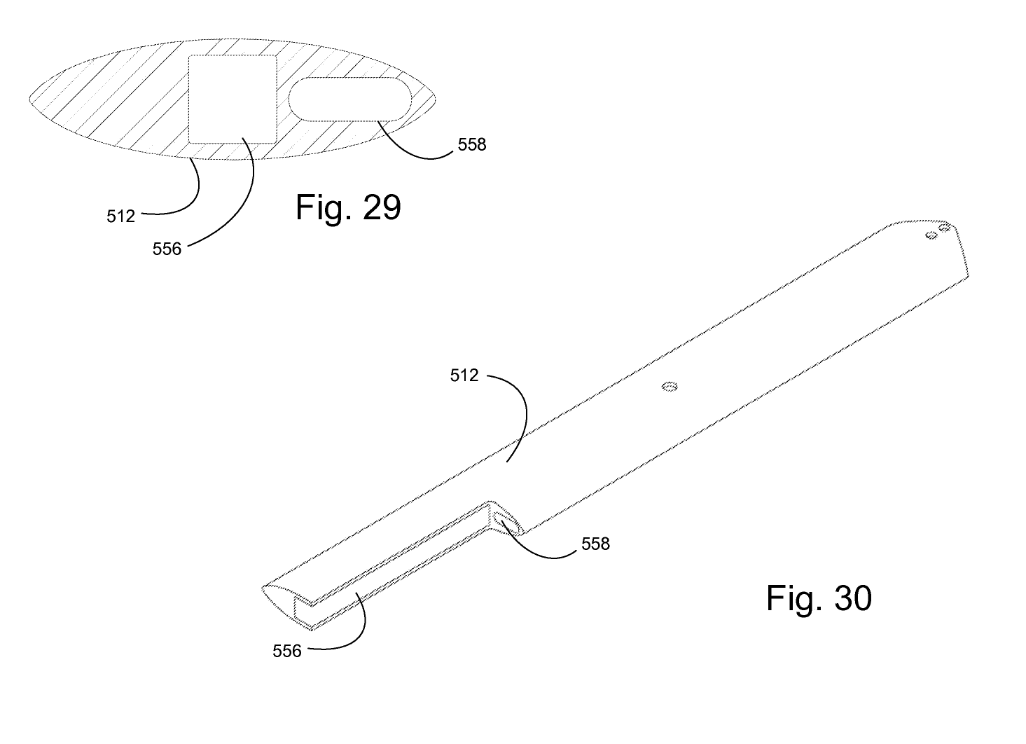

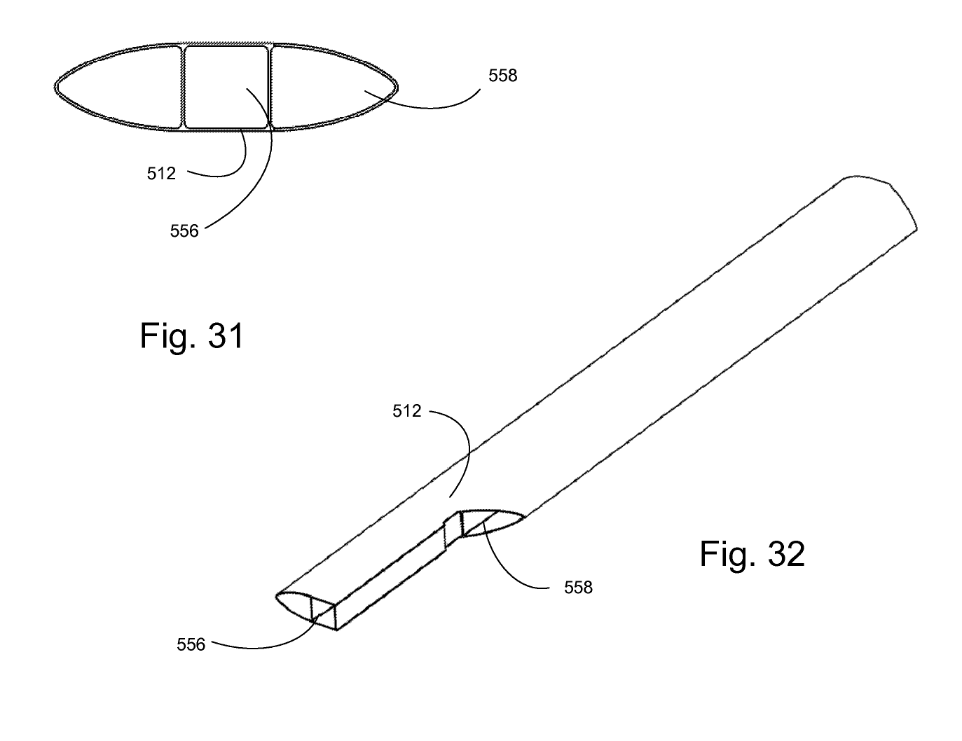

In order to improve aerodynamic efficiency and protect the structural integrity of the mechanism, each strut 104 and actuation rod 208 are disposed within a strut cover 512. Certain embodiments of strut covers are shown in FIGS. 29-32. As seen in these figures, each strut 104 may be disposed within a centrally-located and axially-aligned strut aperture 556, and each actuation rod 208 may be disposed within a parallel actuation rod aperture 558.

It is believed that the operation and construction of the embodiments of the present patent application will be apparent from the Detailed Description set forth above. While the exemplary embodiments shown and described may have been characterized as being preferred, it should be readily understood that various changes and modifications could be made therein without departing from the scope of the present invention as set forth herein.

What is claimed is:

1. A fluid turbine comprising:
a rotor, having an axis of rotation, comprising at least two rotor blades disposed at a radius from the axis of rotation, traveling along a circumferential tangent path line, each rotor blade having a pitch axis and a variable pitch angle; and
a mechanism operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation, according to a non-sinusoidal pitch profile.

2. The fluid turbine of claim 1, wherein the first rotor blade pitch angle is between 7 degrees and 15 degrees to a line tangent to the circumferential path of the rotor blade.

3. The fluid turbine of claim 1, wherein the second rotor blade pitch angle is parallel to a line tangent to the circumferential path of the rotor blade.

4. The fluid turbine of claim 1, wherein the second rotor blade pitch angle is between 20 degrees and 30 degrees to a plane orthogonal to a line tangent to the circumferential path of the rotor blade.

5. The fluid turbine of claim 1, wherein the second rotor pitch angle is between 25 degrees and 35 degrees to a line tangent to the circumferential path of the rotor blade.

6. The fluid turbine of claim 1, wherein the minimum rotor blade pitch angle for a rotor blade is imposed at a rotor position wherein that rotor blade is upstream of the axis of rotation of the rotor blade.

7. The fluid turbine of claim 1, wherein the maximum rotor blade pitch angle for a rotor blade is imposed at a rotor position wherein that rotor blade is downstream of the axis of rotation of the rotor blade.

8. A fluid turbine comprising:
a rotor, having an axis of rotation, comprising at least two rotor blades disposed at a radius from the axis of rotation, each rotor blade having a pitch axis and a variable pitch angle; and
a blade pitch control mechanism comprising a cam and at least one rocker assembly, each rocker assembly comprising a rocker arm operable to pivot about an axis of rotation, the blade pitch control mechanism being operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

9. The fluid turbine of claim 8, wherein the rocker assembly comprises a rocker cartridge which acts as a frame for the rocker assembly.

10. The fluid turbine of claim 9, wherein the rocker cartridge has a cylindrical body protruding from the back of a front flange, and a generally-cylindrical aperture passing from front to back.

11. The fluid turbine of claim 10, wherein a rocker arm is mounted to a shaft passing through the cylindrical aperture in the body of the rocker cartridge, and mounted in such a manner as to pivot about an axis of rotation passing through the aperture.

12. The fluid turbine of claim 11, wherein a cam follower bearing is secured to the distal end of the rocker arm and oriented in such manner as to freely rotate about an axis of rotation generally parallel to, but offset from, the axis of rotation of the rocker arm.

13. The fluid turbine of claim 8, further comprising a lever arm secured to an actuation rod in such a manner as to move an actuation rod as the rocker arm rotates.

14. The fluid turbine of claim 13, wherein the actuation rod is secured at a first end to the rocker arm and at a second end to a rotor blade.

15. A fluid turbine comprising:
a rotor, having an axis of rotation, comprising at least two rotor blades disposed at a radius from the axis of rotation, each rotor blade having a pitch axis and a variable pitch angle; and
a phase-adjustable mechanism operable to control the pitch angle of at least one rotor blade about its pitch axis and to vary the pitch angle of the rotor blade from a first pitch angle at a first circumferential location about the axis of rotation to a second pitch angle at a second circumferential location about the axis of rotation.

16. The fluid turbine of claim 15, wherein the phase-adjustable mechanism comprises a cam having a pitch profile.

17. The fluid turbine of claim 15, wherein the phase of the phase-adjustable mechanism is varied by means of a gear.

18. The fluid turbine of claim 15, wherein the phase-adjustable mechanism comprises a cam secured to a gear mechanism.

19. The fluid turbine of claim 18, wherein the phase-adjustable mechanism further comprises a set of cam followers, each operably connected to a proximal end of an actuating rod having its distal end operably connected to a pitch control linkage point on a rotor blade.

20. The fluid turbine of claim 18, wherein the phase-adjustable mechanism further comprises a motor operably connected to the gear of the gear mechanism.
